(19) United States
(12) Patent Application Publication
(10) Pub. No.: US 2018/0150754 A1
(43) Pub. Date: May 31, 2018

(54) DATA ANALYSIS METHOD, SYSTEM AND NON-TRANSITORY COMPUTER READABLE MEDIUM

(71) Applicant: INDUSTRIAL TECHNOLOGY RESEARCH INSTITUTE, Hsinchu (TW)

(72) Inventors: Hsin-Chien Huang, Tainan City (TW); Wen Tsui, Zhubei City (TW); Chu-An Chung, Zhubei City (TW); Pei-Hsuan Chiang, Chiayi City (TW); Hung-Hsuan Chen, New Taipei City (TW)

(21) Appl. No.: 15/393,554

(22) Filed: Dec. 29, 2016

(30) Foreign Application Priority Data
Nov. 25, 2016 (TW) 105138871

(51) Int. Cl. G06N 5/04; G06N 3/04; G06N 3/08; G06N 7/00

(52) U.S. Cl. CPC G06N 5/04; G06N 7/005; G06N 3/08; G06N 3/04

(57) ABSTRACT

A data analysis method is provided. The data analysis method includes collecting a user data; generating a number of situation conditions from the user data; calculating a distribution ratio of each of the situation conditions to obtain a first data; calculating a success ratio of information association of an information association algorithm under each of the situation conditions to obtain a second data; obtaining at least one evaluating parameter of the information association algorithm under the situation conditions according to the first data and the second data; and generating a suggestion information relating to the information association algorithm according to the at least one evaluating parameter.

This application claims the benefit of Taiwan application Serial No. 105138871, filed Nov. 25, 2016, the disclosure of which is incorporated by reference herein in its entirety.

### TECHNICAL FIELD

The disclosure relates in general to a data analysis method, system and non-transitory computer readable medium.

### BACKGROUND

In today's data analysis, the e-commerce platform typically recommends commodity items to the user by combining a number of recommendation algorithms. Some algorithms recommend commodity items based on price, while some algorithms recommend commodity items mainly for female. If only a single algorithm is used, it is often impossible to meet a variety of possible needs.

In the approach of combining several algorithms, it is usually performed by pre-training the weights for each algorithm, and then adding the results of these algorithms together by using the weights to obtain the final result. This approach could have good performance when these algorithms have similar design logic. However, if the essence of these algorithms is different from each other considerably, risk of decreasing the performance exists. For example, assume the rates that algorithm A recommends the same brands and different brands are 54% and 46%, and the rates that algorithm B recommends the same brands and different brands are 26% and 74%. Assume the results of these two algorithms are combined with the equal weight under all situations. If a user wants to compare the products of the same brand, products of other brands will be recommended since the result of the algorithm B is combined. Therefore, the click-through rate by combining the result of the algorithms A and B will be inevitably lower than the click-through rate by using the result of algorithm A only. The effect of recommendation is clearly not conforming to user's expectation. By using this approach mentioned above cannot bring higher profits for the industry.

### SUMMARY

The disclosure is directed to a data analysis method, system and non-transitory computer readable medium, which could evaluate the performance of various information association algorithms (for example, recommendation algorithm) under each situation condition and provide suggestion information accordingly for analysts. Thereby, the effect of applying the information association algorithm could be improved.

According to one embodiment, a data analysis method is provided. The data analysis method includes collecting a user data; generating a number of situation conditions from the user data; calculating a distribution ratio of each of the situation conditions to obtain a first data; calculating a success ratio of information association of an information association algorithm under each of the situation conditions to obtain a second data; obtaining at least one evaluating parameter of the information association algorithm under the situation conditions according to the first data and the second data; and generating a suggestion information relating to the information association algorithm according to the at least one evaluating parameter.

According to another embodiment, a data analysis system is provided. The a data analysis system includes a data collecting module, a situation condition generating module, an analysis module, an evaluating module, and a suggestion information generating module. The data collecting module collects a user data. The situation condition generating module generates a number of situation conditions from the user data. The analysis module calculates a distribution ratio of each of the situation conditions to obtain a first data, and calculates a success ratio of information association of an information association algorithm under each of the situation conditions to obtain a second data. The evaluating module obtains at least one evaluating parameter of the information association algorithm under the situation conditions according to the first data and the second data. The suggestion information generating module generates a suggestion information relating to the information association algorithm according to the at least one evaluating parameter.

### BRIEF DESCRIPTION OF THE DRAWINGS

FIG. 1 shows a block diagram of a data analysis system according to an embodiment of the disclosure;

FIG. 2 shows the flow chart of the data analysis method according to an embodiment of the disclosure;

FIG. 3 illustrates a flow chart of a data analysis method according to an embodiment of the disclosure;

FIG. 4 illustrates an example of the user data;

FIG. 5 illustrates the recommendation success rates for different information association algorithms under different situation conditions;

FIG. 6 illustrates the generation of different situation conditions from simple to complex; and

FIG. 7 illustrates a block diagram of a data analysis system according to another embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Reference will now be made in detail to the some embodiments of the disclosure, one or more examples of which are illustrated in the figures. Each example is provided by way of explanation of the disclosure and is not meant as a limitation of the disclosure. Further, features illustrated or described as part of one embodiment could be used on or in conjunction with other embodiments to yield yet a further embodiment. It is intended that the description includes such modifications and variations. These embodiments in this disclosure are provided to comply with the legal requirement. Within the following description of the drawings, the same reference numbers refer to same or similar components.

This disclosure provides a data analysis method, system and non-transitory computer readable medium. Different situation conditions could be established according to the indicator to be optimized. Statistical analysis and machine learning could be used to automatically find out the information association algorithms that perform outstandingly in specific situation conditions to help analysts make judgments and reduce the burden on analysts.

The indicator mentioned above refers to a parameter for evaluating the result. Take the e-commerce platform, such as an online shopping platform, for example. The indicator for the e-commerce platform is a click-through rate, for example. The click-through rate is calculated by dividing the number of items in the recommendation list which the users have clicked by the number of items in the recommendation list which is provided when the users browse the products. In this case, the optimization of the indicator is, for example, to increase the click-through rate.

Information association algorithm is, for example, the recommendation algorithms for recommendation system, such as association rule (AR) algorithm, brand-based top popular (BTP) algorithm, co-occurrence (COOC) algorithm, content-based top popular (CTP) algorithm, product to vector (P2V) algorithm, and so on. The information association algorithms could generate one or more Information association items, such as a product recommended list, according to the user's browsing behavior on the website, such as shopping websites. If the indicator to be optimized is the click-through rate, then the description that the performance of the information association algorithm is “outstanding or good” under certain situation condition means that the information association items generated by this information association algorithm could obtain relatively high click-through rate under the certain situation condition.

In addition, in some embodiments, the system will record the distribution curve of these situation conditions after finding the information association algorithm whose performance is “outstanding or good” for some indicator and under some situation condition. The system will provide different applications depending on the situations. For example, when the system finds out that some information association algorithm is favored by female users, the information association result for this information association algorithm may be given according to the user's gender. Besides, it is also possible to long term observe the change of the distribution curve of the information association algorithm which has outstanding performance for some indicator and under some situation condition. And, an alarm will be provided if the deviation of the distribution curve at different time points is large to remind the analysts to notice it and make an early response. The sudden decrease in performance could be avoided.

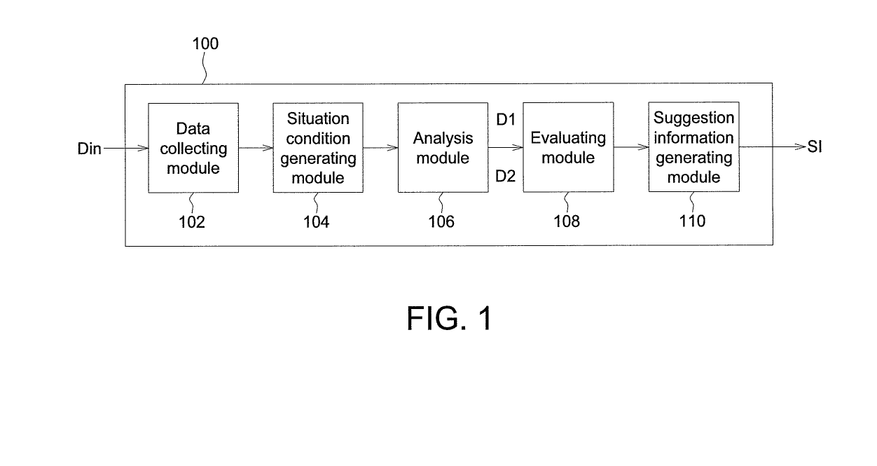

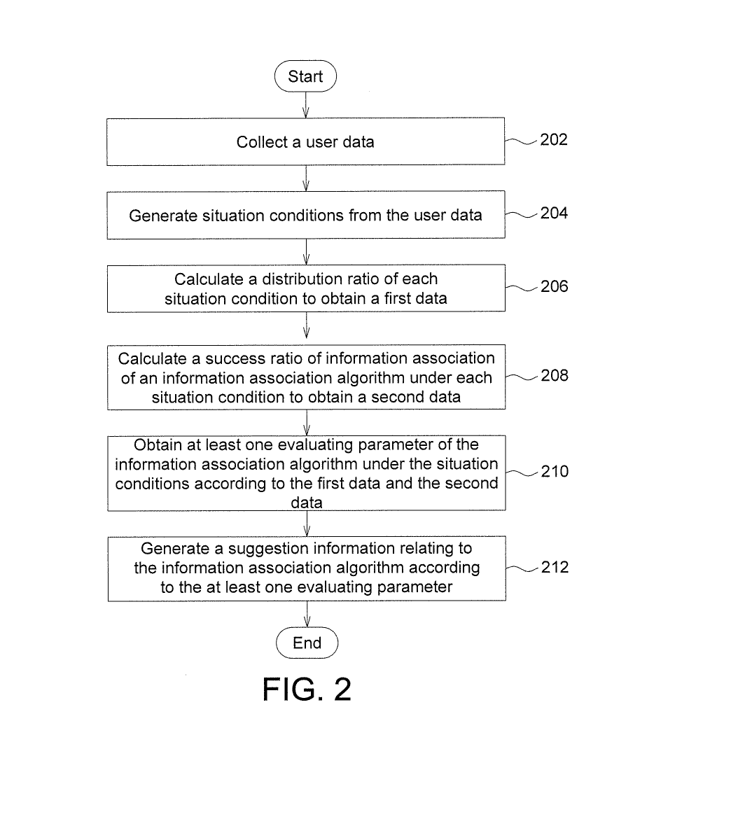

Referring to FIG. 1 and FIG. 2, FIG. 1 shows a block diagram of a data analysis system 100 according to an embodiment of the disclosure, and FIG. 2 shows the flow chart of the data analysis method according to an embodiment of the disclosure.

The data analysis system 100 mainly includes a data collecting module 102, a situation condition generating module 104, an analysis module 106, an evaluating module 108, and a suggestion information generating module 110. Each module of the data analysis system 100 could be implemented by one or more processors, or by the circuits having the ability of data processing. Each module of the data analysis system 100 could also be implemented by firmware or software code, and a computer system could perform the data analysis method of this disclosure after performing the firmware or software code.

In step 202, the data collecting module 102 collects a user data Din. The user data could include a number of data factors. Different data factors represent, for example, different data fields correspond to different data attributes in user data Din. For example, the data factors of the user data Din could include product item, product category, clicking time, product price, and so on, depending on the actual way of data classifying.

In an embodiment, the data collecting module 102 could further quantify the user data Din to simplify the content of the data. For example, the data collecting module 102 could quantify the clicking time (data factor) recorded in minutes to be the clicking time recorded in hours.

In step 204, the situation condition generating module 104 generates a number of situation conditions from the user data Din.

Each situation condition includes one or more data factors in user data Din. In one embodiment, the situation condition generating module 104 obtains the situation conditions by combining the data factors in user data Din based on a machine learning algorithm. For example, a recursive method is performed to obtain the complex situation conditions based on the basic data factors.

The machine learning algorithm mentioned above is, for example, a deep neuron network (DNN) algorithm. However, the disclosure is not limited thereto.

In step 206, the analysis module 106 calculates a distribution ratio of each of the situation conditions to obtain a first data D1.

The distribution ratio refers to the ratio of the number of each situation condition to the population. The population refers to the sum of the number of all situation conditions. For example, assume that the situation conditions include “3C Product”, “Cosmetic Product” and “Food Product”, and the indicator to be optimized is click-through rate, then the distribution ratio of the 3C products in the population is: the number of times the user browses the 3C product/(the number of times the user browses the 3C product+the number of times the user browses the cosmetic product+the number of times the user browses the food product).

In step 208, the analysis module 106 calculates a success ratio of information association of an information association algorithm under each of the situation conditions to obtain a second data D2.

The information association algorithm mentioned above may be selected from a number of existing information association algorithms such as an AR algorithm, a BrandTP algorithm, a COOC algorithm, a CTP algorithm, a P2V algorithm, and the like. If the indicator to be optimized is the click-through rate, the information association is deemed to be successful when the user clicks on the information associated item (such as recommended products) which is generated based on the information association algorithm. The analysis module 106 could obtain the second data D2 by calculating ratio of the number of information association success of the information association algorithm under each of the situation conditions to the total number of information association success.

In step 210, the evaluating module 108 obtains at least one evaluating parameter of the information association algorithm under the situation conditions according to the first data and the second data, to find out the situation condition which makes the indicator have outstanding performance for the information association algorithm.

In one embodiment, the evaluating module 108 obtains the at least one evaluating parameter by calculating a confidence interval of odds ratio of the information association algorithm under each of the situation conditions according to the first data D1 and the second data D2. Take the example in Table I for explanation:

TABLE I

| | 3C Product | Cosmetic Product | Food Product |
|---|---|---|---|
| Population M | 30% | 40% | 30% |
| Information | 50% | 25% | 25% |
| association | | | |
| algorithm M1 | | | |

In this example, the classification of products includes three categories “3C Product”, “Cosmetic Product”, and “Food Product”, and each category corresponds to a situation condition.

The values in the second row of Table I indicate the distribution ratio of each situation condition in respect to population (first data D1). If the click-through rate is selected to be the evaluation criteria, Table I indicates that the number of click-through of 3C product is 30% of the number of total click-through for all kinds of products (population); the number of click-through of cosmetic product is 40% of the number of total click-through, and the number of click-through of food product is 30% of the number of total click-through.

The values in the third row of Table I show the success ratio of information association of information association algorithm M1 under each situation condition (second data D2). The success ratio of information association under particular situation condition could be defined as the number of information association success by adapting the information association algorithm M1 under particular situation condition divided by the total number of information association success by adapting the information association algorithm M1. As shown in Table I, the success ratio of information association for “3C product” by adapting the information association algorithm M1 is 50%, the success ratio of information association for “Cosmetic Product” by adapting the information association algorithm M1 is 25%, the success ratio of information association for “Food Product” by adapting the information association algorithm M1 is 25%.

After obtaining the first data D1 and the second data D2, assuming that the confidence interval is 95%, performance parameters I1 and I2 could be defined as:

$$I 1 = {e}^{ln ( \frac{A * D}{B * C} ) - 1.96 * \sqrt{\frac{1}{100 * A} + \frac{1}{100 * B} + \frac{1}{100 * C} + \frac{1}{100 * D}}}$$

$$I 2 = {e}^{ln ( \frac{A * D}{B * C} ) + 1.96 * \sqrt{\frac{1}{100 * A} + \frac{1}{100 * B} + \frac{1}{100 * C} + \frac{1}{100 * D}}}$$

“A” indicates the recommendation success rate by adapting the information association algorithm M1 under some situation condition (for example, A=50% for 3C product); “B” indicates the recommendation failure ratio by adapting the information association algorithm M1 under some situation condition (for example, B=100%-50%=50% for 3C product); “C” indicates the proportion of this situation condition to population (for example, C=30% for 3C product); and “D” indicates the proportion of the situation conditions other than this situation condition to the population (for example, D=100%-30%=70% for 3C product).

If 1<I1, it indicates that the information association algorithm M1 performs outstandingly under this situation condition. As shown in Table 1, under the situation condition of “3C product”, the performance parameters of the information association algorithm M1 is: I1=1.31, I2=4.17.

If I1<1<I2, it indicates that the information association algorithm M1 performs ordinarily in this situation condition. In Table 1, for example, under the “cosmetic product” situation condition, the performance parameters of the information association algorithm M1 is: I1=0.42, I2=1.45.

If I2<1, it indicates that the information association algorithm M1 performs poorly in this situation condition. In Table 1, for example, under the “food products” situation condition, the performance parameters of the information association algorithm M1 is: I1=0.27, I2=0.91.

Based on the same calculating process, the performance parameters of other existing information association algorithms under each situation condition could be obtained, and the information association algorithm applicable to each situation condition could be evaluated.

In one embodiment, the evaluating module 108 could obtain the at least one evaluating parameter by calculating a cross entropy of the first data D1 and the second data D2.

In step 212, the suggestion information generating module 110 generates a suggestion information S1 relating to the information association algorithm according to the at least one evaluating parameter.

The suggestion information SI may, for example, visually present that an information association algorithm performs well or poorly under certain situation conditions, or indicates that under certain situation conditions, the indicators of all information association algorithms are not outstanding in performance for further amendments by the analyst. The amendments may include modifying the weights of combining the information association algorithms, or change to an appropriate information association algorithm for information association under different situation conditions to improve overall information association performance.

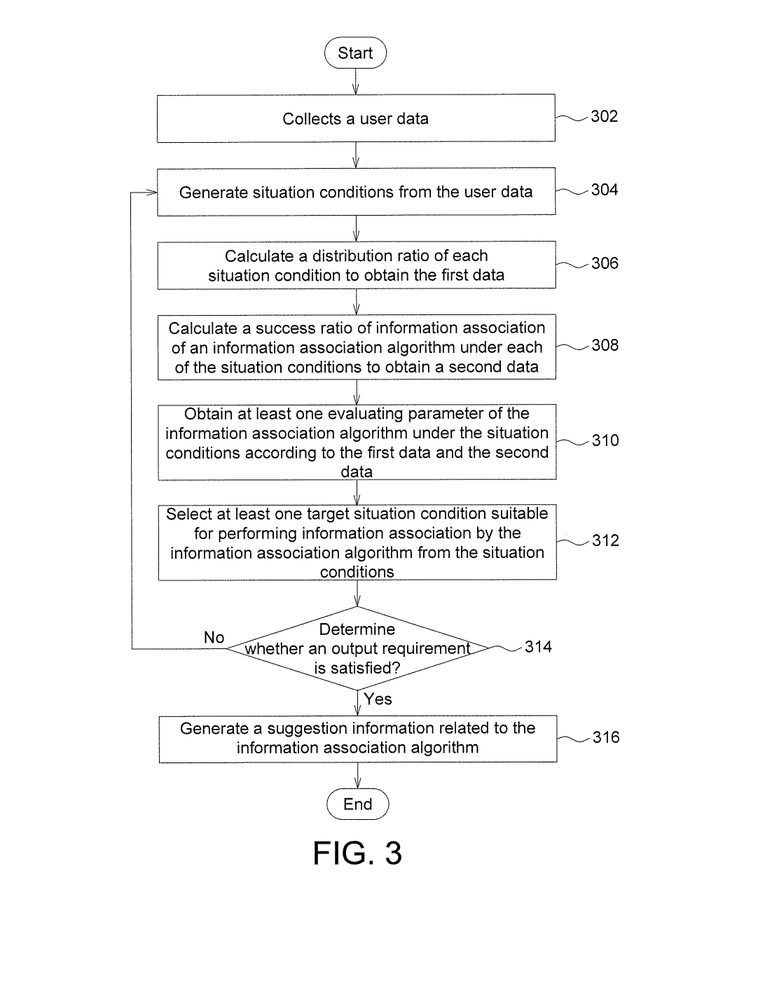

FIG. 3 illustrates a flow chart of a data analysis method according to an embodiment of the disclosure.

In step 302, the data collecting module 102 collects a user data Din.

In step 304, the situation condition generating module 104 generates a number of situation conditions from the user data Din.

In step 306, the analysis module 106 calculates a distribution ratio of each of the situation conditions to obtain the first data D1.

In step 308, the analysis module 106 calculates a success ratio of information association of an information association algorithm under each of the situation conditions to obtain a second data D2.

In step 310, the evaluating module 108 obtains at least one evaluating parameter of the information association algorithm under the situation conditions according to the first data D1 and the second data D2.

In step 312, the evaluating module 108 selects at least one target situation condition suitable for performing information association by the information association algorithm from the situation conditions. That is to say, if the information association algorithm performs well under some situation conditions, then these situation conditions are regarded as the target situation conditions.

In step 314, the evaluating module 108 determines whether the at least one target situation condition satisfies an output requirement. If yes, the suggestion information generating module 110 will generate the suggestion information SI related to the information association algorithm according to the evaluating parameters in step 316; if not, the process will return step 304, in which situation condition generating module 104 will update the situation conditions till the at least one target situation condition correspondingly selected by data analysis system 100 satisfies the output requirement. Then, step 316 is performed to generate the suggestion information SI. In other words, when the output requirement is not satisfied, the data analysis system 100 will perform step 304 to step 314 recursively to try to satisfy the output requirement by forming different situation conditions.

In one embodiment, the situation condition generating module 104 may update the situation conditions by adding more data factors to each situation condition. For example, the data analysis system 100 automatically combines possible data factors in previous level by DNN training to generate more complex situation conditions and finds out the information association algorithm having outstanding performance.

In one embodiment, the output requirement is that a sample coverage rate of the at least one target situation condition to all of the situation conditions is larger or equal to a limit value. The sample coverage rate refers to the ratio of the target situation conditions to the entire population. If the sample coverage rate is too low, e.g., less than 50%, it indicates that the current target situation conditions as a whole are not representative, and the data analysis system 100 will return to step 304 to update the situation conditions till the sample coverage rate corresponding to the generated target situation conditions is greater than or equal to the limit value, which will enable the suggestion information generating module 110 to generate the suggestion information SI.

In another embodiment, the data analysis system 100 controls that the levels for recursion described above do not exceed a certain number of levels (e.g., three levels) in order to avoid excessive computation amount. In this case, the output requirement refers to that the number of data factors that make up each situation condition is less than or equal to a limit value.

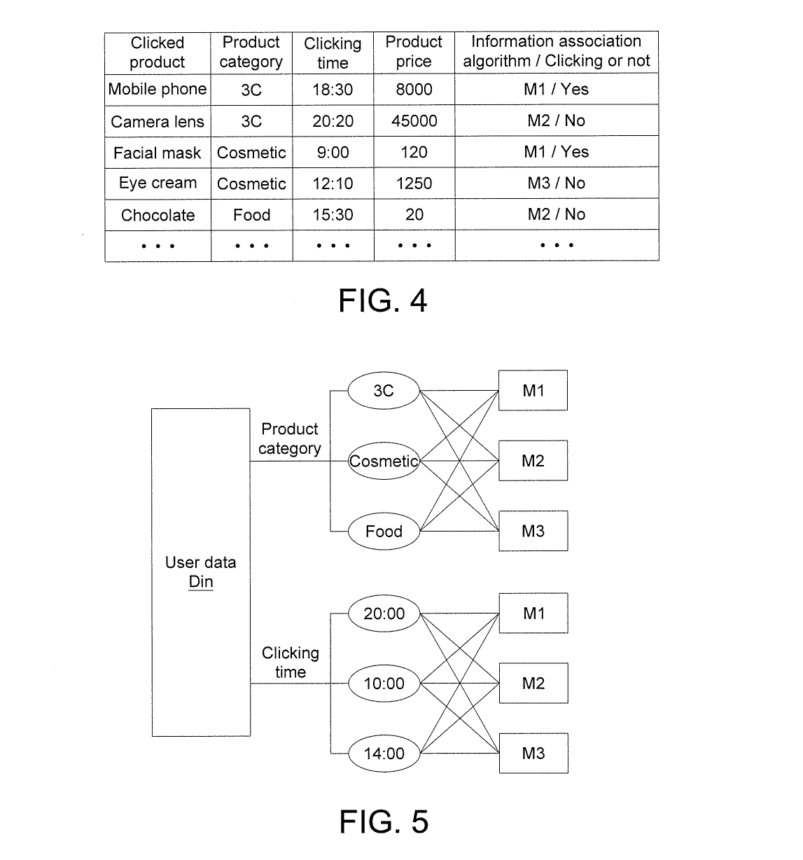

FIG. 4 illustrates an example of the user data Din. In this example, the user data Din includes data fields (data factors) such as “clicked product”, “product category”, “clicking time”, “product price”, “information association algorithm/clicking or not”, and the like. Take the first row for explanation. The first row of data shows that the product clicked by the user is a mobile phone, the product category is 3C product, the clicking time is 18:30, the price of the product is NTD 8,000, and the user clicks the product based on the information association item generated by the information association algorithm M1.

FIG. 5 illustrates the recommendation success rates for different information association algorithms M1, M2, M3 under different situation conditions. In the example of FIG. 5, the data analysis system 100 firstly selects the data factors having high information containing capacity within the permitted calculation range. As shown in FIG. 5, these data factors may be product category (3C product, cosmetic product, and food product), clicking time (10:00 to 11:00, 14:00 to 15:00, 20:00 to 21:00) and so on. The distribution ratio (first data D1) of each data factors in the whole population could be obtained through statistical analysis. For example, 30% of the browsed products are 3C products, 40% are cosmetic products, and 30% are food products.

The data analysis system 100 then calculates the recommendation success rate for various information association algorithms (M1, M2, M3 in this example) under each data factor. For example, the recommendation success rates for the information association algorithm M1 in 3C, cosmetic, food products are 50%, 25%, and 25%, respectively; the recommendation success rates for the information association algorithm M2 in 3C, cosmetic, food products are 30%, 20%, and 50%, respectively; the recommendation success rates for the information association algorithm M3 in 3C, cosmetic, food products are 10%, 55%, 35%, respectively, and so on.

After that, the data analysis system 100 tests each of the information association algorithms M1 to M3 by statistical analysis. If some information association algorithm has quite outstanding performance for a certain situation condition, the suggestion information SI is output to indicate the situation condition and the applicable information association algorithm.

The suggestion information SI may also show that a certain information association algorithm performs poorly under certain situation condition, and performs much worse than other information association algorithms under the same situation condition. This suggestion information SI could be provided for the analyst to improve information association logic of this information association algorithm based on this situation condition.

It is also possible that all existing information association algorithms perform poorly under a particular situation condition. If the proportion of the number of the particular situation condition to the number of population is significantly high (for example, greater than 10%), the suggested information SI could also present this situation for analysts to design suitable recommendation logic for this particular situation condition to improve recommendation performance.

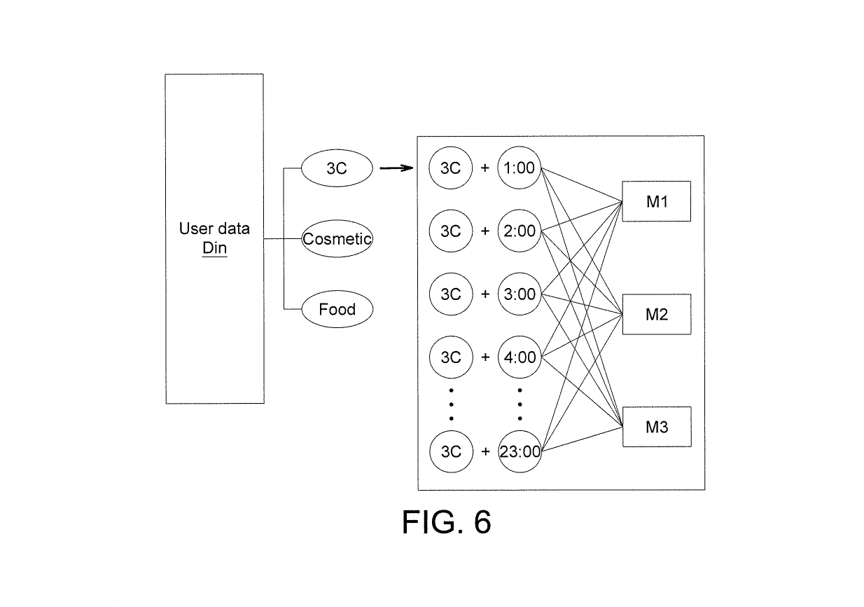

FIG. 6 illustrates the generation of different situation conditions from simple to complex. As shown in FIG. 6, the data analysis system 100 may combine more data factors based on the machine learning algorithm to generate next-stage situation conditions. Take FIG. 6 as an example. At the beginning, each situation condition includes one data factor, such as 3C, cosmetic, or food products. In the next stage, based on the machine learning algorithm, each situation condition will include two data factors. Taking the situation condition “3C+1:00” for example, this indicates that the user browses the 3C product and the clicking time is within the time interval of 1:00 to 1:59.

Take the DNN algorithm for example. The situation conditions in each stage could be considered as DNN nodes in the same stage. Therefore, based on the DNN algorithm logic, the combination of data factors of the situation conditions in the next stage will become more complex.

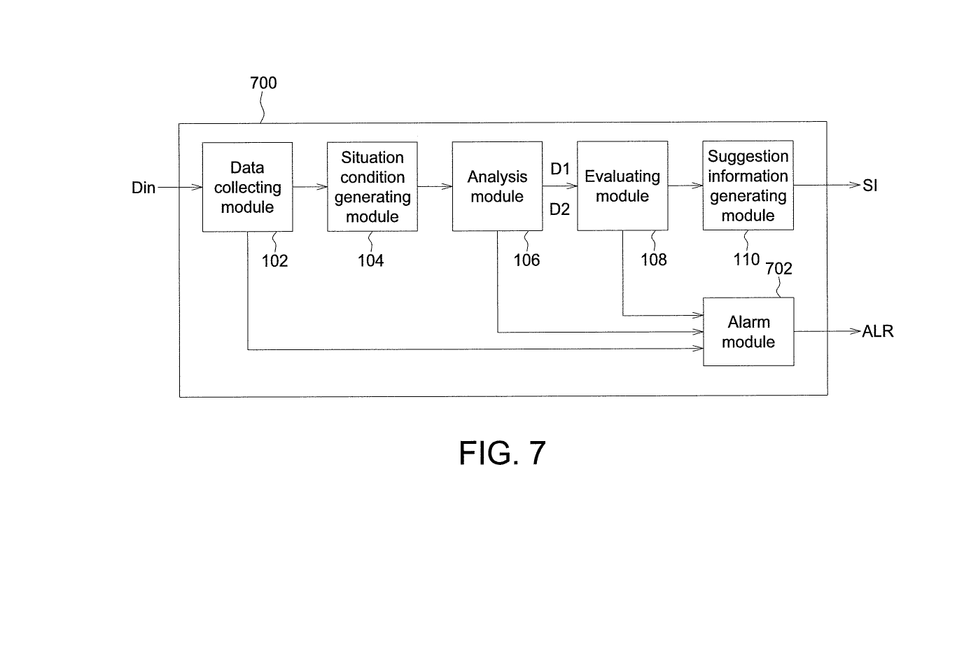

FIG. 7 illustrates a block diagram of a data analysis system 700 according to another embodiment of the present disclosure. The main difference from the data analysis system 100 is that the data analysis system 700 further includes an alarm module 702. The alarm module 702 may be implemented by one or more processors or circuits having data processing capabilities, or may be implemented by firmware or software code.

The alarm module 702 is adapted to generate an alarm information ALR when a degree of deviation in respect of time of at least one of the evaluating parameter and the user data Din meets an alarm condition. For example, if the performance of the information association algorithm MI is outstanding under some situation condition but the performance the information association algorithm MI tends to decrease over time, the alarm module 702 will generate the alarm information when the evaluation parameter is significantly degraded (meeting the alarm condition) to remind analysts to make corresponding adjustments. Alternatively, when the proportion of the number of some situation condition to the number of population tends to increase or decrease over time or the proportion rises and falls by a large margin, the alarm module 702 will automatically notice the analyst about this change and thereby improve the recommendation performance. Alternatively, the alarm module 702 may generate an alarm when the contents of the user data Din are changed a lot. The alarm may be implemented, for example, by sound, light, graphics, text, or a combination thereof.

The present disclosure further provides a non-transient computer-readable medium including an instruction sequence that will make a computer system to perform the data analysis method as described in the present disclosure when the instruction sequence is executed by a processor.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A data analysis method, comprising:
collecting a user data;
generating a plurality of situation conditions from the user data;
calculating a distribution ratio of each of the situation conditions to obtain a first data;
calculating a success ratio of information association of an information association algorithm under each of the situation conditions to obtain a second data;
obtaining at least one evaluating parameter of the information association algorithm under the situation conditions according to the first data and the second data; and
generating a suggestion information relating to the information association algorithm according to the at least one evaluating parameter.

2. The data analysis method according to claim 1, wherein the user data comprises a plurality of data factors, the method further comprises:
obtaining each of the situation conditions by combining the data factors based on a machine learning algorithm.

3. The data analysis method according to claim 2, wherein the machine learning algorithm is a deep neuron network (DNN) algorithm.

4. The data analysis method according to claim 1, further comprising:
obtaining at least one evaluating parameter by calculating a confidence interval of odds ratio of the information association algorithm under each of the situation conditions according to the first data and the second data.

5. The data analysis method according to claim 1, further comprising:
obtaining the at least one evaluating parameter by calculating a cross entropy of the first data and the second data.

6. The data analysis method according to claim 1, further comprising:
selecting at least one target situation condition suitable for performing information association by the information association algorithm from the situation conditions according to the at least one evaluating parameter;
determining whether the at least one target situation condition satisfies a output requirement;
generating the suggestion information when the at least one target situation condition satisfies the output requirement; and
updating the situation conditions till the at least one correspondingly selected target situation condition satisfies the output requirement when the at least one target situation condition does not satisfy the output requirement, and generating the suggestion information.

7. The data analysis method according to claim 6, wherein the output requirement is that a sample coverage rate of the at least one target situation condition to all of the situation conditions is larger or equal to a limit value.

8. The data analysis method according to claim 6, wherein the user data comprises a plurality of data factors to be combined to form each of the situation conditions, the output requirement is the number of the data factors that make up each of the situation conditions is less or equal to a limit value.

9. The data analysis method according to claim 6, wherein the user data comprises a plurality of data factors, each of the situation conditions is made up at least one of the data factors, the method further comprises:
including more data factors into each of the situation conditions to update each of the situation conditions.

10. The data analysis method according to claim 1, further comprising:
generating an alarm information when a degree of deviation in respect of time of at least one of the at least one evaluating parameter and the user data conforms to an alarm condition.

11. A non-transitory computer readable medium having an instruction sequence, a computer system performs the data analysis method according to claim 1 when the instruction sequence is performed by a processor.

12. A data analysis system, comprising:
a data collecting module, for collecting a user data;
a situation condition generating module, for generating a plurality of situation conditions from the user data;
an analysis module, for calculating a distribution ratio of each of the situation conditions to obtain a first data, and calculating a success ratio of information association of an information association algorithm under each of the situation conditions to obtain a second data;
an evaluating module, for obtaining at least one evaluating parameter of the information association algorithm under the situation conditions according to the first data and the second data; and
a suggestion information generating module, for generating a suggestion information relating to the information association algorithm according to the at least one evaluating parameter.

13. The data analysis system according to claim 12, wherein the user data comprises a plurality of data factors, the situation condition generating module is further adapted to obtain each of the situation conditions by combining the data factors based on a machine learning algorithm.

14. The data analysis system according to claim 13, wherein the machine learning algorithm is a deep neuron network algorithm.

15. The data analysis system according to claim 12, wherein the evaluating module is further adapted to obtain at least one evaluating parameter by calculating a confidence interval of odds ratio of the information association algorithm under each of the situation conditions according to the first data and the second data.

16. The data analysis system according to claim 12, wherein the evaluating module is further adapted to obtain the at least one evaluating parameter by calculating a cross entropy of the first data and the second data.

17. The data analysis system according to claim 12, wherein the evaluating module is further adapted to:
select at least one target situation condition suitable for performing information association by the information association algorithm from the situation conditions according to the at least one evaluating parameter;
determine whether the at least one target situation condition satisfies a output requirement;
make the suggestion information generating module generate the suggestion information when the at least one target situation condition satisfies the output requirement; and
update the situation conditions till the at least one correspondingly selected target situation condition satisfies the output requirement when the at least one target situation condition does not satisfy the output requirement, and make the suggestion information generating module generate the suggestion information.

18. The data analysis system according to claim 17, wherein the output requirement is that a sample coverage rate of the at least one target situation condition to all of the situation conditions is larger or equal to a limit value.

19. The data analysis system according to claim 17, wherein the user data comprises a plurality of data factors to be combined to form each of the situation conditions, the output requirement is that the number of the data factors that make up each of the situation conditions is less or equal to a limit value.

20. The data analysis system according to claim 17, wherein the user data comprises a plurality of data factors, each of the situation conditions is made up at least one of the data factors, and the situation condition generating module is further adapted to include more data factors into each of the situation conditions to update each of the situation conditions.

21. The data analysis system according to claim 12, further comprising:
an alarm module for generating an alarm information when a degree of deviation in respect of time of at least one of the at least one evaluating parameter and the user data conforms to an alarm condition.
